(19) United States
(12) Patent Application Publication
(10) Pub. No.: US 2006/0161666 A1
(43) Pub. Date: Jul. 20, 2006

(54) Apparatus and method for controlling use of instant messaging content

(75) Inventors: Gabriel Aaron Cohen, Raleigh, NC (US); Ronald Eugene Craig, Pittsboro, NC (US); Gerald Laverte Mitchell JR., Raleigh, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/039,727

(22) Filed: Jan. 18, 2005

(51) Int. Cl. G06F 15/16; H04L 9/32; G06K 9/00

(52) U.S. Cl. 709/229; 726/4

(57) ABSTRACT

An apparatus and method is provided for use in instant messaging or chat conversations between participants at client computer terminals or work stations. When a participant wants to save some or all of the chat transcript, the participant actively requests consent from all other participants. The consent request includes the specific content to be saved, and provides a variety of options for responding to the request, such as to approve, disapprove, or delete selected text. In a useful embodiment, apparatus for controlling use of chat content includes a content control device located at least at a first one of the client stations, the control device connected to regulate use by a first station of specified chat content received from at least a second station. A content request device operable at the first station sends a message requesting permission to selectively use the specified chat content, and a request response device at the second station sends a response request message to either prevent the first station from propagating the specified chat content, or else approving selective use by the first station of at least a portion of the specified content.

### CROSS-REFERENCE TO RELATED APPLICATIONS

This application is related to commonly assigned and co-pending U.S. patent application Ser. No. ______ (Attorney Docket No. RSW920040184US1) entitled “Apparatus and Method for Controlling Use of Individual Segments of Instant Messaging Content”; and U.S. patent application Ser. No. ______ (Attorney Docket No. RSW920040185US1) entitled “Apparatus and Method for Limiting Access to Instant Messaging Content on a Display Screen”.

### BACKGROUND OF THE INVENTION

1. Technical Field

The invention disclosed and claimed herein generally pertains to an apparatus and method for preventing unintended use or dissemination of information content exchanged between participants during instant messaging conversations. More particularly, the invention pertains to apparatus of the above type wherein respective participants operate client computer stations that are remotely located from one another. Even more particularly, the invention pertains to apparatus of the above type wherein message content may not be retained or used further by a participant without explicit consent from other participants.

2. Description of Related Art

Businesses increasingly are relying on a diverse set of electronic communication tools in the work place. Accordingly, security measures that have been in place for some time on more traditional forms of business communications, such as letters, should now be applied to the increasingly broad spectrum of electronic business communications. This is necessary to control propagation and prevent unintended dissemination of sensitive business information.

Previously, efforts made to prevent proliferation of information in the new electronic mediums for communication have generally been directed to email. One solution in the email space is to attach a flag to an email which prevents the forwarding of the email. This flag can also prevent clipboard copying of the text. However, in the case of email this can be easily thwarted, such as by taking pictures of the screen or using a non-compliant email system.

Another important type of electronic communication is known by those of skill in the art as instant messaging, or chat. In an instant messaging or chat conversation, two or more participants operate client work stations that are remotely located from one another, but are also interconnected to enable bidirectional communication by all participants. Thus, one participant can send a message to another, and immediately receive back a response or reply. The instant messaging configuration enables participants located at different places to discuss a topic, or to discuss multiple topics. Moreover, the configuration can remain in place over time, so that the participants can exchange messages during a period extending over days or longer.

It will be readily apparent that a great deal of important and valuable information content can be generated and exchanged in the course of an instant messaging or chat conversation. Thus, as this communication medium is increasingly used in the work place, it becomes necessary to enforce controls on the use that is made of content generated through this medium. In the past, improper use of this medium and content produced thereby has resulted in misunderstandings, dissemination of private information and disclosure of sensitive business data. Currently, transcripts can be saved and forwarded, and text can be clipped and copied. Often out of context, chat content may be sent along through an unpredictable chain to the wrong parties. Moreover, certain solutions available in the email space generally do not apply in the realm of instant messaging. Unlike email, content in the medium of instant messaging is not discrete, in the sense that it is not neatly divided into individual notes which can be identified by subject and marked as sensitive. Thus, it is necessary to control the information contained within a chat transcript more granularly, even line by line. Also, since chat content is often non-topical in nature, a chat configuration involving two or more participants can remain open for days at a time, and can cover a variety of unrelated subjects.

### BRIEF SUMMARY OF THE INVENTION

In accordance with the invention, when an instant messaging participant wants to save the chat transcript, or even copy a section of the chat transcript to the participant's computer clipboard, the chat client will actively request consent from all chat participants that are online. Without this consent, it will not be possible to save, copy or otherwise easily propagate the content of the chat conversation. For participants that are not online, persistent policies may be pre-established, to indicate whether they will allow their contributions to the chat conversation to be saved. A consent request sent to a participant will include the specific content to be saved or propagated by the requesting participant, and will provide a variety of options for responding to the request, such as to approve, disapprove, or delete selected text. In a useful embodiment of the invention, apparatus is provided for controlling use of chat content exchanged between participants during instant messaging events, wherein the participants are located at different client work stations. The apparatus includes a content control device located at least at a first one of the stations, the control device connected to regulate use by the first station of chat content received from at least a second station. The apparatus further includes a content request device operable by the participant at the first station to send a message requesting permission to selectively use specified chat content received from the second station. A request response device at the second station sends a response request message to the content control device, the response message selectively operating the content control device to either prevent the first station from retaining or otherwise propagating the specified chat content, or else approving selective use by the first station of at least a portion of the specified content.

### BRIEF DESCRIPTION OF THE SEVERAL VIEWS OF THE DRAWINGS

The novel features believed characteristic of the invention are set forth in the appended claims. The invention itself, however, as well as a preferred mode of use and further objectives and advantages thereof, will best be understood by reference to the following detailed description of an illustrative embodiment when read in conjunction with the accompanying drawings, wherein:

FIG. 1 is a schematic diagram showing a configuration of client work stations for implementing an embodiment of the invention.

FIG. 2 is a block diagram showing components at respective client work stations of FIG. 1 for implementing an embodiment of the invention.

FIG. 3 is a flow chart further illustrating an embodiment of the invention.

### DETAILED DESCRIPTION OF THE INVENTION

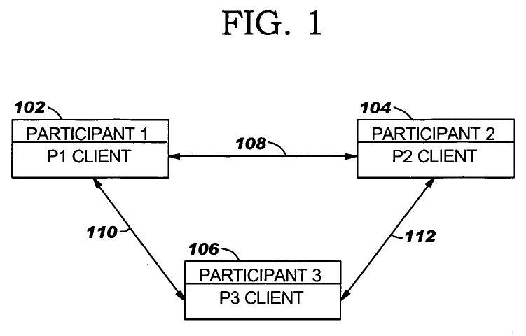

Referring to FIG. 1, there is shown a configuration of clients or client work stations 102-106, wherein each client is connected to every other client by means of bidirectional communication links or paths 108-112. As used herein, the terms “client” and “client work station” refer to a computer or other data processing work station operable by a user to communicate with other computer work stations, over a network or other communication path. Communication paths 108-112 may compromise, for example, segments of the Internet, wireless communication links, or electro-optical communication paths, such as fiber optic cables. Thus, Participants 1-3, shown by FIG. 1 to be located at clients 102-106 respectively, may operate their respective client work stations to exchange information with one another. More particularly, Participants 1-3 of clients 102-106 are disposed to engage in instant messaging or chat communication with one another, as described above. Propagation of the chat information content disclosed among the instant messaging participants is intended to be controlled or regulated in accordance with an embodiment of the invention, as described herein.

In the realm of instant messaging, the presence of the client users or participants provides a significant advantage in implementing propagation controls on chat content. Recognizing this, the invention requires that when a chat participant desires to save a chat transcript to his/her client data storage, or even seeks to copy a section of the chat transcript to the clipboard of his/her client work station, the participant must first request consent to do so from all other chat participants. Without this consent, the participant will not be able to save, copy or otherwise easily propagate the content generated during the instant messaging activity.

As used herein, the terms “propagate”, “propagation” and any variations thereof are broadly defined, to include any acts whereby content is transferred to or stored or reproduced at a location external to a client computer, and to further include retention or storage of content within the client computer such that, at some time in the future, content could be transferred to or stored or reproduced at a location external to the client computer.

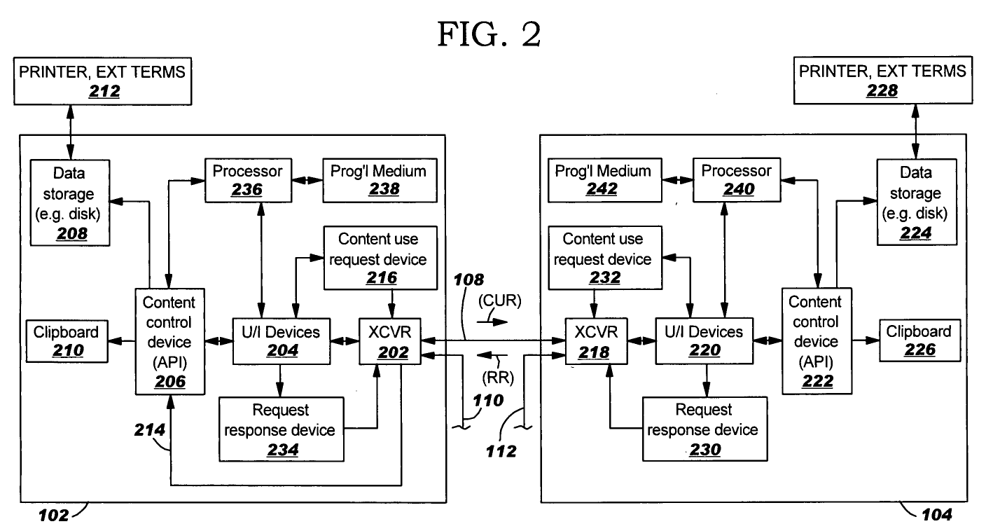

Referring to FIG. 2, there are shown client stations 102 and 104 respectively provided with components for implementing an embodiment of the invention. Referring specifically to client 102, there is shown a transceiver 202 connected to send and receive message data over links 108 and 110. Transceiver 202, by way of example and not limitation, may alternatively include a modem configured to access the Internet, an RF transceiver for accessing a wireless network, or an electro-optic coupling device for connecting to a fiber optic transmission path. Transceiver 202 also includes any components needed for data conversion, in order to enable data exchanges between transceiver 202 and user interface (U/I) devices 204 of client 102. In FIG. 2, U/I devices 204 is intended to collectively include all individual user interface devices that client 102 is provided with, which will occur to those of skill in the art. U/I devices 204 may include, for example, a monitor or display device for enabling Participant 1 to view incoming chat messages received by transceiver 202, as well as a keyboard for use in generating messages to be sent out from client 102.

Referring further to FIG. 2, there is shown a content control device 206 positioned between U/I devices 204 and all data storage capability 208 of client 102. Data storage 208 shown in FIG. 2 is intended to include the hard drive as well as all other disks and devices used to store data within client 102. FIG. 2 further shows that any messages to be sent to clipboard 210 of client 102 must likewise be routed through content control device 206. Thus, any chat message received by client 102 can be viewed by means of a U/I device 204. However, the message content cannot be saved or stored in client 102, unless this is permitted by content control device 206. Moreover, FIG. 2 shows that any connection to a printer or other terminals 212 external to client 102 must be made through data storage 208. Accordingly, content control device 206 may also be used to prevent or selectively limit the printing of received chat messages, and the transfer thereof to any computers or other devices that are external to client 102.

In one useful implementation, content control device 206 includes an application programmable interface (API) that is operated by instructions sent thereto over a link 214, as described hereinafter in further detail.

As discussed above, when Participant 1 desires to save the chat transcript or a selected portion thereof, he/she must first obtain consent to do so from each of the other instant messaging participants. Accordingly, client 102 is equipped with a content use request device 216, interconnected to U/I devices 204. To obtain consent from Participant 2 of client 104 to use chat content, Participant 1 operates content use request device 216 to send a content use request (CUR) message to client 104. The CUR message will present Participant 2 with the specific content from the instant messaging conversation that Participant 1 intends to save or otherwise propagate. If transceiver 202 recognizes that client 104 is not online when the CUR message is sent, notice of this is provided to U/I devices 204, in order to notify Participant 1.

Referring now to client 104 in FIG. 2, there is shown a transceiver 218, U/I devices 220, a content control device 222, and data storage 224. There is further shown a clipboard 226, a printer and external terminals 228 connected to the data storage 224, and a content use request device 232. Each of these components of client 104 is similar or identical to the corresponding component shown in client 102, and has functions and interconnections that are respectively similar or identical thereto, as described above.

Client 104 is further provided with a request response device 230. When a CUR message sent from client 102 is received at client 104, Participant 2 operates a U/I device 220 and request response device 230 to generate a request response (RR) message. The request response message may either approve or disapprove retaining or otherwise propagating the chat content specified in the CUR message. The response request may also delete or censor selected text from the specified chat content, while approving propagation of the remaining content. Usefully, Participant 2 can use normal text highlighting to mark the particular text that should be expurgated from the otherwise approved chat content.

When granting consent to Participant 1, Participant 2 and any other approving participant can specify that the approver's name must be automatically removed from the chat transcript, before any content thereof can be saved, forwarded or otherwise propagated. Third party names, in addition to respective chat content contributors, may also be deleted from otherwise approved chat content. Moreover, if client 106 is online when a CUR message is sent from client 102, the CUR message would preferably be sent simultaneously to both clients 104 and 106. The request responses received back from Participants 2 and 3 would then be combined, to determine what chat content, if any, could be saved or propagated by client 1.

FIG. 2 shows client 1 provided with a response request device 234 similar to device 230, for use in responding to CUR messages sent to client 102 from other clients.

When transceiver 202 receives response request messages from one or more participants, an instruction representing the response or combined responses is sent to content control device 206 over link 214. The instruction operates device 206 to (1) prevent all chat content from passing to data storage 208 or clipboard 210; (2) allow all chat content to pass freely thereto; or (3) prevent disapproved content from passing thereto, while allowing the remainder to pass.

FIG. 2 further shows client 102 provided with a processor 236 and a programmable or computer readable medium 238, of selected type, for use in storing software used to control operation of respective components of client 102, as described above. Client 104 is similarly provided with a processor 240 and a computer readable medium 242.

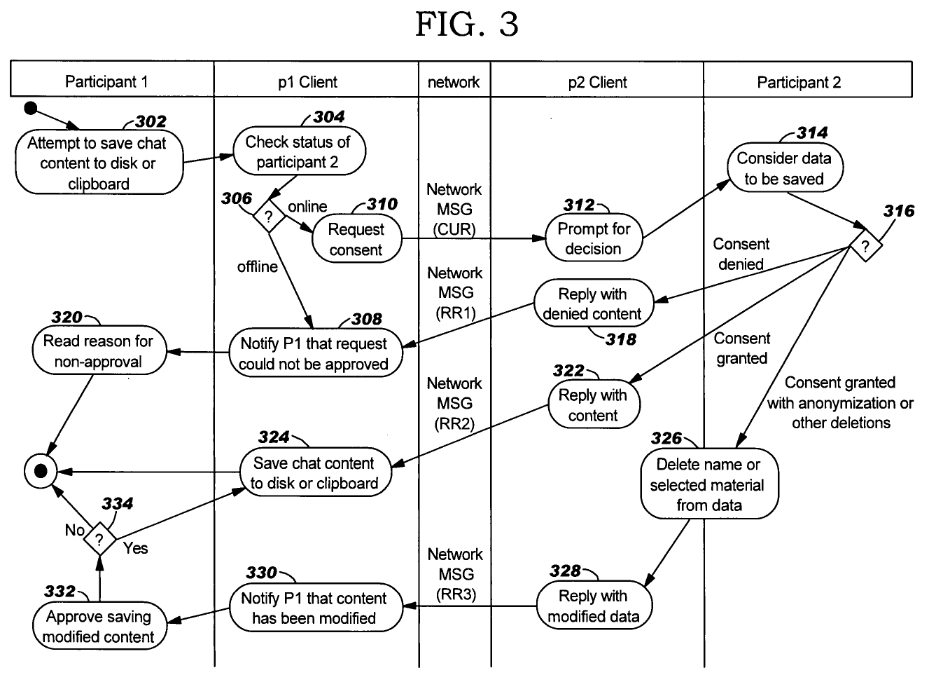

Referring to FIG. 3, there is shown a flow chart further illustrating alternative events that can occur when clients 102 and 104, as depicted in FIGS. 1 and 2, are operated in accordance with an embodiment of the invention. At function block 302, Participant 1 attempts to save specified chat content, such as to disk storage 208 or to clipboard 210. As discussed above, this can be carried out by Participant 1 operating U/I device 204 to send a CUR message pertaining to the specified content to p2 client 104.

Function block 304 shows that an initial step in generating a CUR message is to check the status of Participant 2 and the associated client 104. Usefully, content use request device 216 is configured to interact with transceiver 202 to determine whether client 104 is in an online or offline condition. Decision block 306 indicates that if client 104 is found to be offline, Participant 1 will be notified that the content use request could not be approved, as shown by function block 308.

If p2 client 104 is online, function block 310 indicates that the CUR message requesting consent to use specified chat content will be sent to client 104, over a network including link 108 as previously described. At client 104, the CUR message will be displayed to Participant 2, to prompt Participant 2 to consider the use request, as shown by function blocks 312 and 314.

Referring further to FIG. 3, there are shown three types of decisions provided by decision block 316. One type of decision would be to deny Participant 1 consent to save the specified chat content. When this occurs, response request device 230 would generate a message (RR1) as indicated by function block 318, for transmission to p1 client 102. Participant 1 would again be notified that the request could not be approved, per function block 308. Function block 320 shows that Participant 1 would be informed of the particular reason for non-approval.

A second type of decision would be to consent to the use of unlimited specified chat content, whereupon a corresponding message (RR2) would be sent to client 102, as shown by function block 322. This message would operate content control device 206 to enable the chat content to be saved to disk or clipboard, as described above and shown by function block 324.

The third type of decision, shown by function blocks 326 and 328, would be to remove a name(s) and/or selected material from the specified chat content, and approve the request of Participant 1 to save the remainder. This is implemented by a response request message (RR3) setting forth the name(s) and/or the material to be deleted. Function block 330 indicates that Participant 1 must be notified of the resulting content modification, so that he/she can decide whether or not to save the modified content, as indicated by function block 332 and decision block 334. If the modified content is to be saved, content control device 206 will respond to the RR3 message by enabling only the approved content to be saved.

In some embodiments of the invention, participants may pre-establish persistent policies to indicate whether they will or will not allow their instant messaging conversations to be saved. These policies could then be referred to in the event that one participant was not online when another participant was seeking consent to save text from the conversation. Participants could also establish particular policies per conversation, for example by email.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In a configuration of client work stations interconnected to enable instant messaging between participants at respective stations, apparatus for controlling use of chat content exchanged between participants during said instant messaging, wherein said apparatus comprises:
a content control device located at least at a first one of said stations, said control device connected to regulate use by said first station of specified chat content received from at least a second one of said stations;
a content use request device operable by the participant of said first station to send a message at least to said second station requesting permission to use said specified chat content; and
a request response device at said second station for sending a request response message to said content control device, said response message selectively operating said content control device to either prevent said first station from retaining or otherwise propagating said specified chat content, or to allow selective use by said first station of at least a portion of said specified chat content.

2. The apparatus of claim 1, wherein:
one of said content control devices is located at each of said client work stations, the content control device at a particular station being responsive to request response messages received from each of the other stations.

3. The apparatus of claim 1, wherein:
said first station sends said message requesting permission to selectively use said specified chat content to each of a plurality of other stations; and
a request response device at each of said plurality of other stations is operable to send a request response message to said first station, in reply to said message requesting permission.

4. The apparatus of claim 3, wherein:
said content device at said first station is operable to regulate use of said specified chat content in accordance with an instruction derived by combining instructions contained in said request response messages sent to said first station from each of said plurality of other stations.

5. The apparatus of claim 3, wherein:
said content control device is adapted to prevent said first station from propagating said specified chat content prior to receipt at said first station of a request response message from each of said plurality of other stations.

6. The apparatus of claim 3, wherein:
at least one of said plurality of other stations is adapted to respond to said message requesting permission in accordance with a pre-established policy, when said at least one other station is offline from said configuration of stations.

7. The apparatus of claim 1, wherein:
said request response message allows said specified chat content to be propagated by said first station without any limitations.

8. The apparatus of claim 1, wherein:
said request response message allows said specified chat content to be propagated by said first station only after the names of one or more specified individuals are removed from association with said specified chat content.

9. The apparatus of claim 1, wherein:
said request response message allows said first station to propagate only an identified portion of said specified chat content.

10. The apparatus of claim 1, wherein:
said content control device is provided with an application programmable interface (API) disposed to prevent said first station from propagating any portion of said specified chat content in the absence of a content use instruction from said second station consenting thereto that is contained in said request response message sent from said second station.

11. In a configuration of client work stations interconnected to enable instant messaging between participants at respective stations, a method for controlling use of chat content exchanged between participants during said instant messaging events, said method comprising the steps of:
sending a content use request message from a first station to at least a second station, said content use message requesting permission to use specified chat content;
sending a request response message from said second station to said first station as a reply to said content use request, said request response message containing an instruction to either prevent said first station from propagating said specified chat content, or to enable selective use by said first station of at least a portion of said specified chat content; and
operating said first station in accordance with said instruction.

12. The method of claim 11, wherein:
said first station is disposed to send a content use request message requesting permission to selectively use said specified chat content to each of a plurality of other stations; and
each of said plurality of other stations sends a request response message to said first station in reply to said content use request, each of said request response messages sent from said plurality of other stations containing an instruction to said first station; and
said first station is operated to regulate use of said specified chat content in accordance with an instruction derived by combining the respective instructions contained in said request response message sent to said first station from said plurality of other stations.

13. The method of claim 12, wherein:
said first station is prevented from propagating said specified chat content prior to receipt at said first station of a request respond message from each of said plurality of other stations.

14. The method of claim 13, wherein:
at least one of said plurality of other stations is adapted to respond to said content use request message in accordance with a pre-established policy, when said at least one other station is offline from said configuration of stations.

15. The method of claim 11, wherein:
one of said instructions to enable selective use by said first station comprises at least a first, a second or a third instruction, said first instruction enabling said specified chat content to be propagated by said first station without any limitations, said second instruction enabling said specified chat content to be propagated by said first station only after the names of one or more specified individuals are removed from association with said specified chat content, and said third instruction enabling said first station to propagate only an identified portion of said specified chat content.

16. In a configuration of client work stations interconnected to enable instant messaging between participants at respective stations, a computer program product in a computer readable medium for controlling use of chat content exchanged between participants during said instant messaging events, said computer program product comprising:
a first instruction for sending a content use request message from a first station to at least a second station, said content use message requesting permission to use specified chat content;
a second instruction for receiving a request response message sent from said second station to said first station as a reply to said content use request, said request response message containing an instruction to either prevent said first station from propagating said specified chat content, or to enable selective use by said first station of at least a portion of said specified chat content; and
a third instruction for operating said first station in accordance with said instruction.

17. The computer program product of claim 16, wherein:
said first station is disposed to send a content use request message requesting permission to selectively use said specified chat content to each of a plurality of other stations; and
each of said plurality of other stations sends a request response message to said first station in reply to said content use request, each of said request response messages sent from said plurality of other stations containing an instruction to said first station; and
said first station is operated to regulate use of said specified chat content in accordance with an instruction derived by combining the respective instructions contained in said request response message sent to said first station from said plurality of other stations.

18. The computer program product of claim 17, wherein:
said first station is prevented from propagating said specified chat content prior to receipt at said first station of a request response message from each of said plurality of other stations.

19. The computer program product of claim 18, wherein:
at least one of said plurality of other stations is adapted to respond to said content use request message in accordance with a pre-established policy, when said at least one other station is offline from said configuration of stations.

20. The computer program product of claim 16, wherein:
one of said instructions to enable selective use by said first station comprises at least a first, a second or a third command, said first command enabling said specified chat content to be propagated by said first station without any limitations, said second command enabling said specified chat content to be propagated by said first station only after the names of one or more specified individuals are removed from association with said specified chat content, and said third command enabling said first station to propagate only an identified portion of said specified chat content.
